(19) United States
(12) Patent Application Publication
(10) Pub. No.: US 2009/0129436 A1
(43) Pub. Date: May 21, 2009

(54) Method and device for measuring the temperature of an exhaust gas flow in an exhaust line of an internal combustion engine

(75) Inventors: Manfred Glehr, Wenzenbach (DE); Stephan Heinrich, Pfeffenhausen (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens VDO Automotive AG, Regensburg (DE)

(21) Appl. No.: 11/921,893

(22) PCT Filed: May 4, 2006
(86) PCT No.: PCT/EP2006/062053

§ 371 Date: Dec. 10, 2007

(30) Foreign Application Priority Data
Jun. 10, 2005 (DE) 10 2005 027 005.0

(51) Int. Cl. G01J 5/08

(52) U.S. Cl. 374/130

(57) ABSTRACT

A device for measuring a temperature of an exhaust gas flow in an exhaust branch of an exhaust gas section of an internal combustion engine is disclosed. A sub-region of the exhaust branch is configured as a parabolic mirror having a focal point positioned outside of the exhaust branch. The device includes a side channel member attached to the exhaust branch and having an open end adjacent to the exhaust branch and a closed end; and a radiation sensitive sensor disposed in the side channel member and at the focal point. The open end is in fluid communication with an interior of the exhaust branch through a cutout of the exhaust branch so that the sensor is coupled to radiation of the exhaust gas flow for measuring a temperature of the exhaust gas flow. A related method is also disclosed.

The present invention relates to a method and a device for measuring a temperature of an exhaust gas flow in an exhaust gas section of an internal combustion engine.

In the course of introducing and implementing the EURO-IV standard, the motor manufacturers for gasoline and diesel internal combustion engines are continuing to work on effectively improving exhaust gas aftertreatment. This requires the use of temperature sensors for measuring exhaust gas temperatures in the exhaust gas section of the internal combustion engines for a temperature range from approximately 200° C. to approximately 1100° C. The accuracy of a temperature measurement at approximately 1050° C. is intended in this case to be higher than +/−5° C.

According to the prior art, temperature sensors for temperature measurements are known that are applied as thick film circuits to ceramic material as carrier. In this case, the ceramic material also serves at the same time as an electric insulator. However, for the abovenamed temperature range the problem arises as early as temperatures starting from approximately 650° C. that ceramic materials become semiconducting. Consequently, such sensors supply corrupted measurement results owing to the flow of fault currents in high temperature ranges. Temperature sensors currently available on the market are likewise affected by this problem, these temperature sensors operating according to two measurement principles that essentially differ from one another. One measurement method operates with platinum or platinum alloys as resistance material, which is respectively applied to the ceramic substrate. The other measurement method uses at least one thermocouple that is likewise arranged on an insulating ceramic with connected electronics.

It is the object of the present invention to provide a method and a device for a very accurate temperature measurement of exhaust gases guided in the exhaust gas section of an internal combustion engine in the above-named large temperature range in conjunction with increased accuracy.

This object is achieved by means of the features of the independent claims. Consequently, an inventive temperature measuring device has a sensor, arranged outside the exhaust gas section, that is coupled to the thermal radiation of the exhaust gas. By contrast with temperature sensors known from the prior art, an inventive device therefore measures the temperature of the exhaust gas not directly, but indirectly via the thermal radiation of the exhaust gas flow. In this case, the thermal radiation of the exhaust gas flow is guided outward or out of the exhaust gas section for the purpose of measurement.

Advantageous designs are the subject matter of the respective subclaims. Consequently, the temperature measuring device has a sensor arranged outside an exhaust branch of the exhaust gas section. In particular, the sensor is arranged in an end-closed side channel. The end-closed side channel is connected to the exhaust branch via a cutout. In this case, substantially thermal radiation is coupled out as radiation.

In one embodiment of the invention, a measuring point is selected as a subregion of the exhaust branch as a first component of the exhaust gas section when viewed from the engine. The exhaust gases have the highest temperature at the exhaust branch as first component of the exhaust gas section, as a result of which it is possible to obtain the best measured values for subsequent regulation of the internal combustion engine. In this first embodiment, the exhaust branch is designed in a predetermined region approximately as a parabolic mirror. A radiation sensitive sensor element is arranged in an end-closed side channel of the exhaust branch at a focal point of this subregion. In accordance with basic optical laws, this arrangement directs diverging rays as a parallel ray bundle and/or a bundle of rays aligned in parallel out of the exhaust gas and onto the sensor element in the side channel in a fashion focused by the quasi-parabolic mirror.

As also in the following exemplary embodiments, in this first embodiment of the invention instead of being measured directly the temperature is already measured indirectly via outwardly guided radiation of the exhaust gas flow. In this case, the sensor itself is advantageously not seated in the gas flow, thus enabling a very substantial temperature reduction at the sensor by comparison with devices of the prior art. A substantial thermal decoupling from the high temperature of the material of the exhaust branch is also effected by the arrangement in a side channel that is fixed on the exhaust branch in an end-closed fashion. Consequently, a sensor in an inventive configuration does not reach the same high temperatures to which sensors of the prior art are exposed. Moreover, the end-closed side channel acts as protection against radiation from the external surroundings of the sensor as well as, in particular, EMC protection.

In an alternative embodiment of the invention, the sensor is accommodated in an end-closed side channel connected to the exhaust branch. The sensor element is arranged at a spacing from the closed end, the closure of the side channel being designed as a parabolic mirror. The sensor itself is arranged at a distance, prescribed by the geometric parameters of the parabolic mirror in the side channel upstream of the parabolic mirror and approximately at the focal point thereof, such that thermal radiation acts directly from the exhaust branch on the sensor element arranged approximately on the central axis of this side channel. Additionally, thermal radiation focused by a rear side is incident on the sensor element from the exhaust gas flow. This amplification and focusing of thermal radiation from the exhaust gas flow raises the measuring accuracy and sensitivity of the sensor.

In a preferred embodiment of the invention, the end-closed side channel is arranged substantially along the central axis of a flanged region of the exhaust branch or in a fashion offset parallel thereto.

A further embodiment of the invention constitutes a modification of the above-described embodiment to the effect that a close mesh structure is provided at an end of the side channel open toward the exhaust branch in order to focus the thermal radiation originating from the exhaust gas flow, the sensor element itself being arranged at a primary maximum of the diffraction pattern thus produced.

As an alternative thereto, the grating can be replaced by a grating diaphragm or by a positive lens acting transparently at least in the infrared region. This last-named embodiment has the advantage of hermetically sealing the side channel from the exhaust gas flow. It follows that in the side channel, which remains relatively cool by comparison with the exhaust branch that is very strongly heated during operation, there is no need despite the low temperatures to expect an accumulation of deposits and/or condensates that could lead in the long run to an impairment at least of the sensitivity of the sensor.

In a preferred embodiment, the sensor element comprises a semiconductor element such as, for example, a semiconductor diode that is sensitive at least in an infrared region. As an alternative thereto, the temperature sensor can be designed as a thermocouple. This thermocouple can be designed in the form of a blackened resistor, that is to say as a “gray body” in thermodynamic terms. Also coming into consideration as thermocouples are blackened NTC, PTC or platinum thermistors.

An evaluation of the sensor signal or a number of sensor signals is performed in an electronic system that in a preferred embodiment of the invention is fitted remote from the actual exhaust gas pipe and/or the side channel in order to provide a further thermal barrier. The electronic system conditions the signals and passes them on as digital signal to a higher order electronic system. In this case, radiation components that originate directly from the combustion chamber or the cylinder interior, and radiation components emitted by the hot walls of the exhaust branch can be removed from the measurement result by calculation using mathematical methods.

The overall result of an inventive arrangement is a temperature measuring device that, on the one hand, enables the high requisite measuring accuracy of approximately +/−3° C. at 1000° C. and, on the other hand, excludes additional sources of error such as could occur, for example, in the case of analog signal transmission, owing to the transmission of the specific temperature of the exhaust gas flow in the form of digital data. In addition, this device can also be used to measure temperatures of 1100° C., and even higher temperatures, with good accuracy.

It follows that it is also possible to use an inventive measuring device for any type of high temperature measurement over and above the present exclusively treated case of use in temperature measurement of exhaust gas flows from internal combustion engines such as are used, in particular, in passenger cars.

Further advantages of an inventive device are described in more detail below with reference to the illustration of exemplary embodiments and with the aid of the drawing, in which, in schematic illustration:

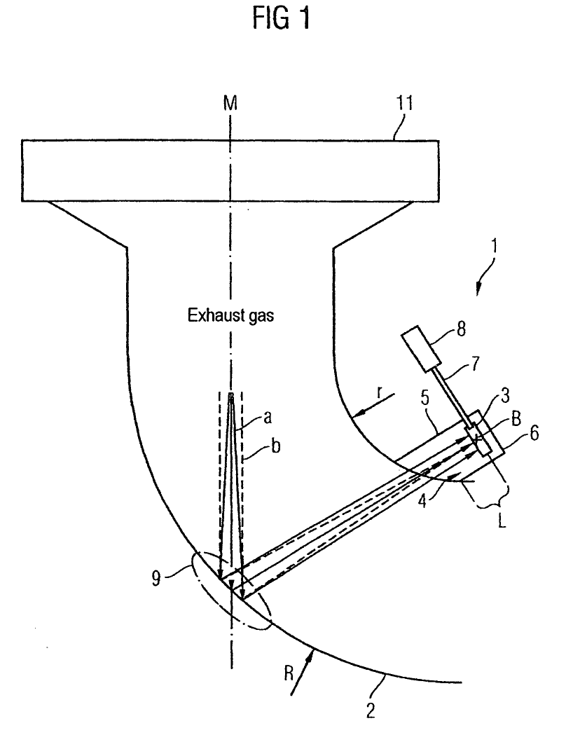

FIG. 1 shows a section through an exhaust branch having a sensor element in a connected side channel;

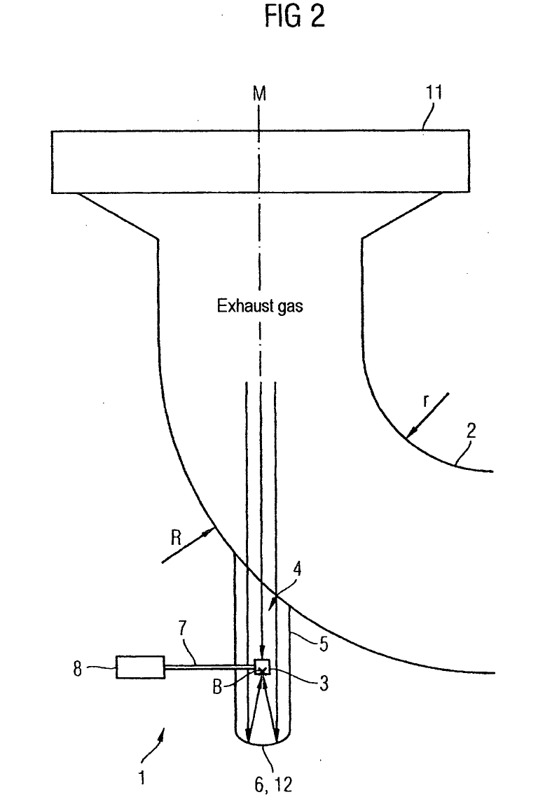

FIG. 2 shows a second embodiment of the invention, having a sensor element arranged in a side channel of the exhaust branch with its own parabolic mirror;

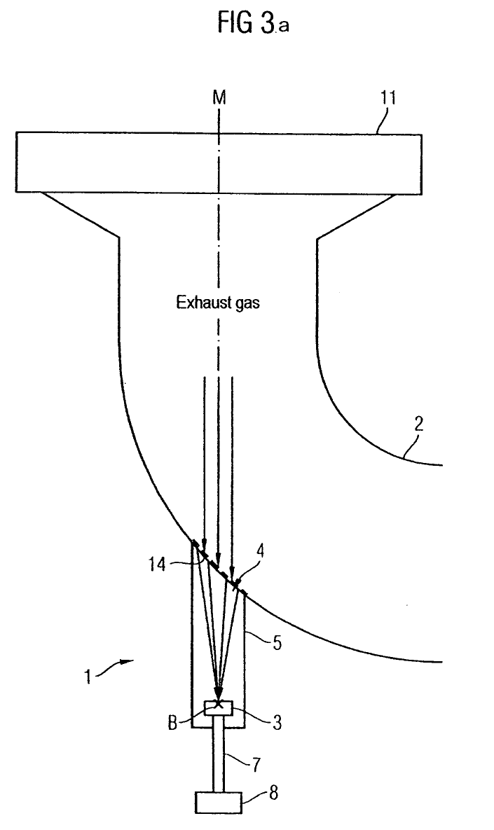

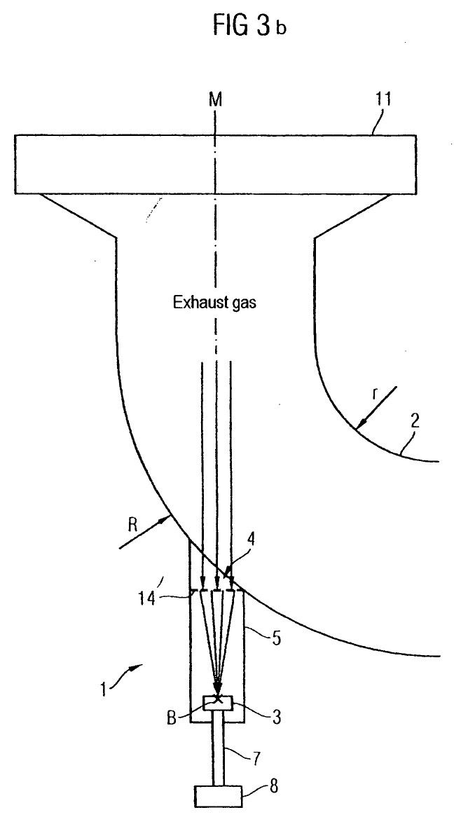

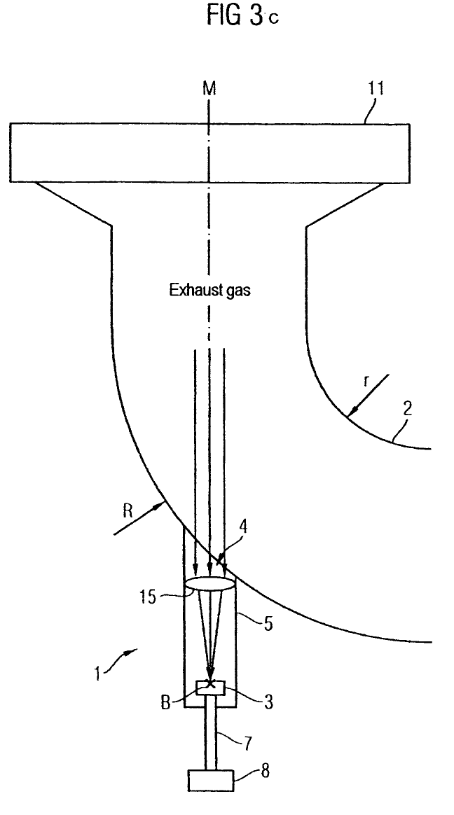

FIG. 3a shows a third exemplary embodiment in which, in a modification of the exemplary embodiment known from FIG. 2, a grating for focusing the thermal radiation onto a sensor element is provided at a free end of an exhaust branch;

FIG. 3b shows a modification of the embodiments of FIGS. 2 and 3a with an altered arrangement of the grating element, and

FIG. 3c shows a further modification of the embodiments of FIGS. 2, 3a and 3b, in the case of which an infrared lens is provided at the inlet of the side channel of the exhaust branch in order to focus the thermal radiation from the exhaust gas flow onto the sensor element.

In the individual illustrations of exemplary embodiments, the same constituents and components are uniformly provided throughout with the same reference symbols in the drawing.

In all following exemplary embodiments described with reference to the drawing, a device 1 is provided on an exhaust branch 2 as a subregion of the exhaust gas section near the engine for the purpose of measuring the temperature of exhaust gases of an internal combustion engine that are guided in an exhaust gas section. The further course of the exhaust gas section is not further illustrated subsequently in the drawing. The exhaust branch 2 constitutes the first element of the exhaust gas section. In this region, selected for a measurement, of the exhaust branch 2, the exhaust gases have the highest temperature when seen over the entire exhaust gas section. In all subsequently described exemplary embodiments of the invention, radiation is coupled out of the exhaust gas flow in this region, led out from the exhaust gas section and guided onto a sensor.

Across all the exemplary embodiments of the invention, an inventive temperature measuring device 1 is arranged outside the exhaust branch 2 and has a sensor element 3 arranged outside the exhaust gas flow at an inside radius r or an outside radius R. The sensor element 3 is coupled to the exhaust gas flow via the thermal radiation thereof. To this end, the exhaust branch 2 has a cutout 4 to which an end-closed side channel 5 is connected in a permanently sealed fashion. Since the side channel 5 is arranged in the region of an inside radius of the exhaust branch 2, and in addition is also end closed, it experiences only very little incident flow from the hot exhaust gases of the exhaust gas flow (not further depicted). There is also a contribution to this in that the exhaust branch 2 has an inside diameter of up to approximately 40 mm for a cylinder or a cylinder pair, whereas the side channel 5 has only an inside diameter of less than approximately 10 mm. Consequently, the side channel 5 has a substantially higher flow resistance than the exhaust branch 2, and this additionally obstructs an inflow of hot exhaust gases.

In addition, the sensor element 3 is arranged near a closed end region 6 of the side channel 5 such that the sensor element 3 also experiences only a thermal load that is slight by comparison with known sensor elements of the prior art, owing to a minimal distance prescribed by the length L from the strongly heated wall material of the exhaust branch 2.

Furthermore, over all the exemplary embodiments of the drawing, the sensor element 3 is connected to a plug via a connecting line 7, or directly to its own sensor electronic system 8, as a result of which the thermal loading of the plug or of the sensor electronic system 8 is further reduced in regions that can be used with conventional components along with optimization of the conditions for installing and connecting the device 1.

In the exemplary embodiment of FIG. 1, the exhaust branch 2 is designed in a predetermined subregion 9 at the outside radius R approximately as a parabolic mirror for the thermal radiation emitted by the hot exhaust gases. At a focal point B of this subregion 9, the sensor element 3 is arranged in the end-closed side channel 5. Owing to the subregion 9, of approximately parabolic design, of the exhaust branch 2, in accordance with known basic optical laws, diverging thermal radiation of the exhaust gases, represented as a with a continuous line in the illustration of FIG. 1, is deflected as a parallel ray bundle through the cutout 4 onto the sensor element 3 in the side channel 5. In addition, thermal radiation is also focused from the exhaust gas flow onto the sensor element 3, and this is illustrated by a dashed line b in FIG. 1. In the case of indirect measurement of a temperature of the exhaust gas flow and further reaching thermal decoupling of the sensor element 3 and of a plug or a sensor electronic system 8 from the higher temperatures of the exhaust gas, the above-described arrangement focuses the radiative action of the hot exhaust gas flow, particularly in the infrared region. A high accuracy of operational temperature measurement in a high temperature range is thereby implemented with high measurement sensitivity.

The sensor element 3 itself can comprise a semiconductor element such as, for example, a semiconductor diode that is sensitive particularly in the infrared region. In the present exemplary embodiment, the sensor element 3 is, however, designed as a thermocouple, specifically in the form of a gray body, when viewed thermodynamically, in the form of a blackened NTC thermistor. Alternatively, in other exemplary embodiments of the invention use is made of PTC or platinum thermistors as sensor elements 3.

In a second embodiment of the invention, in accordance with FIG. 2 a device 1 has been transferred to the outside radius R of the exhaust branch 2. The side channel 5 extends in this case axially in a fashion substantially parallel to a central axis M of a flanged region 11 or attached region of the exhaust branch 2 via which the exhaust branch 2 is connected to an engine block (not further illustrated) in the region of the exhaust valves of the internal combustion engine. In this exemplary embodiment of the invention, the side channel 5 is provided with a closed end 6 designed as a parabolic mirror 12. The sensor element 3 is arranged in the side channel 5 at a distance removed from the closed end 6 that is prescribed by the geometric parameters of this parabolic mirror 12, such that the sensor element 3 is also approximately at a focal point B in this case. Consequently, thermal radiation emitted by the hot exhaust gas falls through the cutout 4 approximately in the flow direction of the exhaust gas onto the sensor element 3, while radiation incident through the opening 4 in a substantially parallel fashion in the direction of the sensor element 3 is reflected at the parabolic mirror, and is focused onto the sensor element 3 from behind, as it were. Thus, once again, a focusing effect of the thermal radiation emitted by the hot exhaust gas has been implemented for the purpose of increasing the measurement accuracy and the sensitivity of the sensor element 3 of the device 1. The size of the sensor element can also be reduced by an arrangement at a focal point.

On the basis of the design and the fundamental arrangement of the device 1 of FIG. 2, the embodiments of FIGS. 3a to 3c describe devices 1 that focus thermal radiation from the hot exhaust gas flow onto the sensor element 3. The sensor element 3 is, furthermore, arranged in an end-closed side channel 5 outside the exhaust gas section. In the embodiment in accordance with FIG. 3a, the sensor element is arranged in an end-closed side channel 5 as has already been described in principle with reference to the embodiment of FIG. 1. The closed end 6 of the side channel 5 therefore need not in principle exhibit any particular geometric shape. By contrast with the above-described exemplary embodiments, however, the cutout 4 in the exhaust branch 2 is now at least partially closed again by a grating structure 14. The grating structure 14 thereby substantially follows the shape of the outer shell of the exhaust branch 2 in the region of the outside radius R. Focusing of the thermal radiation originating from the exhaust gas flow is now implemented by the grating structure 14, which is designed as a close mesh grating. The sensor element 3 is arranged in the end-closed side channel 5 at a principal maximum or in a central diffraction pattern of the grating diffraction thus produced. The grating structure 14 can be formed to this end as a grating diaphragm made from a material acting transparently at least in the infrared region, or from a grating or crossed grating produced from wire.

The embodiment of FIG. 3b constitutes an alternative to the embodiment of FIG. 3a to the effect that the grating structure 14 no longer follows the outer contour, represented in the illustration of FIG. 3b with a continuous line, of the exhaust branch 2 in the region of the outside radius R. However, the grating structure 14 is substantially perpendicular to an axis along which the side channel 5 extends.

In a further embodiment, a positive lens 15 acting transparently at least in the infrared region is used approximately at the site of the grating structure 14 as a direct alternative to the illustration of the device 1 in FIG. 3b. This positive lens 15 consists of germanium in the present case. By contrast with all the preceding embodiments, the embodiment of FIG. 3c has the advantage of even being able to hermetically seal the side channel 5 permanently against the gases of the exhaust branch 2. It has been observed that the exhaust branch 2 is so highly loaded thermally during operation that in no case does it come to the building up of solid deposits and/or condensates. The side channel 5 is, however, itself relatively cool by comparison with the exhaust branch 2, which is very strongly heated during operation. The solution proposed in the exemplary embodiment in accordance with FIG. 3c effectively permanently opposes accumulation of deposits and/or condensates in the region of the sensor element as coolest region of the overall device 1 accompanied by an expected impairment at least of the sensitivity of the sensor element 3.

1.-16. (canceled)

17. A method for measuring a temperature of an exhaust gas flow in an exhaust branch of an exhaust gas section of an internal combustion engine, a sub-region of the exhaust branch being configured as a parabolic mirror having a focal point, the method comprising the steps of:
positioning a radiation sensitive sensor at the focal point and in a side channel member attached to the exhaust branch, the side channel member having an open end in communication with an interior of the exhaust branch through a cutout of the exhaust branch, and a closed end;
leading radiation of the exhaust gas flow out of the exhaust gas section and into the side channel member;
guiding the radiation of the exhaust gas flow to the sensor for measurement using the parabolic mirror.

18. The method of claim 17, wherein the radiation comprises substantially thermal radiation.

19. The method of claim 17, wherein the step of guiding comprises focusing the radiation onto the sensor using the parabolic mirror.

20. A device for measuring a temperature of an exhaust gas flow in an exhaust branch of an exhaust gas section of an internal combustion engine, a sub-region of the exhaust branch being configured as a parabolic mirror having a focal point positioned outside of the exhaust branch, the device comprising:
a side channel member attached to the exhaust branch and having an open end adjacent to the exhaust branch and a closed end; and
a radiation sensitive sensor disposed in the side channel member and at the focal point,
wherein the open end is in communication with an interior of the exhaust branch through a cutout of the exhaust branch so that the sensor is coupled to radiation of the exhaust gas flow for measuring a temperature of the exhaust gas flow.

21. A device for measuring a temperature of an exhaust gas flow in an exhaust branch of an exhaust gas section of an internal combustion engine, the device comprising:
a side channel member attached to the exhaust branch and having an open end adjacent to the exhaust branch and a closed end disposed outside of the exhaust branch, the side channel member being disposed substantially parallel to a central axis of a flanged region of the exhaust branch; and
a radiation sensitive sensor disposed in the side channel member and coupled to radiation of the exhaust gas flow for measuring a temperature of the exhaust gas flow.

22. The device of claim 21, wherein the closed end of the side channel member is configured as a parabolic mirror having a focal point positioned outside of the exhaust branch, the sensor being disposed at the focal point.

23. The device of claim 21, further comprising a grating structure disposed adjacent to the open end of the side channel member for focusing the radiation onto the sensor.

24. The device of claim 23, wherein the grating structure is configured to produce a diffraction pattern with a principal maximum, the sensor being disposed at the principal maximum.

25. The device of claim 21, further comprising a positive lens disposed adjacent to the open end of the side channel member, the positive lens acting transparently at least in the infrared region and being configured to focus the radiation onto the sensor.

26. The device of claim 25, wherein the positive lens comprises germanium.

27. The device of claim 25, wherein the positive lens is configured to produce a diffraction pattern having a focal point, the sensor being disposed at the focal point.

28. The device of claim 21, wherein the sensor comprises an infrared-sensitive semiconductor element.

29. The device of claim 28, wherein the infrared-sensitive semiconductor element comprises a semiconductor diode.

30. The device of claim 20, wherein the sensor comprises an infrared-sensitive semiconductor element.

31. The device of claim 30, wherein the infrared-sensitive semiconductor element comprises a semiconductor diode.

32. The device of claim 21, wherein the sensor comprises a thermocouple.

33. The device of claim 32, wherein the thermocouple comprises one of a blackened resistor, a blackened NTC, a blackened PTC and a platinum thermistor.

34. The device of claim 20, wherein the sensor comprises a thermocouple.

35. The device of claim 34, wherein the thermocouple comprises one of a blackened resistor, a blackened NTC, a blackened PTC and a platinum thermistor.

36. The device of claim 23, wherein the grating structure produces a diffraction pattern having a focal point and the sensor is disposed at the focal point of the diffraction pattern.
